(19) United States
(12) Patent Application Publication
(10) Pub. No.: US 2003/0112504 A1
(43) Pub. Date: Jun. 19, 2003

(54) Arrangement for confocal autofocussing

(76) Inventors: Norbert Czarnetzki, Jena (DE); Thomas Scheruebl, Jena (DE)

Correspondence Address: REED SMITH, LLP, ATTN: PATENT RECORDS DEPARTMENT, 599 LEXINGTON AVENUE, 29TH FLOOR, NEW YORK, NY, 10022-7650, US

(21) Appl. No.: 10/276,631

(22) PCT Filed: May 5, 2001
(86) PCT No.: PCT/EP01/05080

(30) Foreign Application Priority Data
May 18, 2000 (DE) 100 24 685.0

(51) Int. Cl. G02B 21/00; G02B 21/06

(52) U.S. Cl. 359/383; 359/368; 359/385; 359/386

(57) ABSTRACT

The invention is directed to an arrangement for confocal autofocusing of optical devices, preferably for fine focusing of microscopes, in which an illumination beam path is directed onto an observed object, and image information from the surface of the observed object as well as information about the focus position is obtained from the light that is reflected in an objective by the observed object and, based on this information, a correction of the focus position is carried out by means of an evaluating and adjusting unit. In a device of the type described herein, the image information and the information about the focus position are guided in different, spatially separated optical branches. A light bundle serving as image transmission branch runs in the center of the objective beam path and an autofocusing branch runs at the periphery of the objective beam path and has three optical channels, a first optical channel supplies an extrafocal signal, a second optical channel supplies an intrafocal signal and a third optical channel supplies a conjugate signal in corresponding autofocusing image planes.

The invention is directed to an arrangement for confocal autofocusing of optical devices, preferably of microscopes, in which an illumination beam path is directed to an observed object, and image information from the surface of the observed object as well as information about the focus position can be obtained from the light that is reflected into an objective by the observed object and, based on this information, the focus position can be corrected by means of an evaluating and adjusting unit.

For reliable and, when possible, automatic focusing of optical devices such as microscopes or projectors, for example, the main optical transmission system is often used for focusing; that is, the image information about the object to be observed and information for evaluating the focus position is obtained from the objective beam path. The latter information is used for readjusting the focus chiefly in continuous fabrication processes in which the product and/or its surface must be monitored when the focus position drifts for some reason and the image is out of focus.

This is also the case particularly in arrangements in which the imaging object or object plane is scanned point by point. While adequate results are usually achieved with respect to the resolution in the direction of the optical z-axis, it is disadvantageous that a highly accurate refocusing on height-structured or reflection-structured surfaces, edges and thin-film systems is still beset by problems.

When focus measurement light bundles are coupled into the main beam path dichromatically, problems result above all because a focus spot is fed back to the main image due to insufficient blocking in the sensitivity range of the receiver, due to the occurrence of z-offset in sharpness detection in the autofocusing bundle relative to the main bundle, due to chromatic aberration, and due to optical malfunctions in the transmission system in the wavelength range of the autofocus system.

Point-scanning and confocal systems are used in microscopy to achieve a good depth resolution and a good contrast. Scanning systems with Nipkow disks, such as those described, for example, in DE 195 11 937 C2, or special pinhole arrays for a linearly scanning image construction play a decisive role in this connection. For this purpose, high-resolution autofocus systems are required in addition to fast scanning methods. Scanning image construction using pinhole arrays is described, for example, in the periodical “Materialprüfung [Material Testing]”, 39/1997, volume 6, pages 264 ff.

In order to achieve accurate autofocusing, a plurality of measurement bundles were used in the previous known methods and arrangements to obtain information from the spatially averaged measurements about a height profile or about other surface characteristics of an observed object.

Proceeding from this prior art, it is the object of the invention to further develop an arrangement for confocal autofocusing of the type described in the beginning so as to ensure fast and reliable monitoring of focusing on structured surfaces, edges and thin-film systems.

According to the invention, in a device of the type described in the beginning, the image information and the information about the focus position run in different, spatially separated optical branches within the objective beam path.

Due to the fact that at least one image transmission branch and one autofocusing branch are guided separately, the total image bundle that can be transmitted is made use of for transmitting a main image field as well as an autofocus image field and, further, a broad capture range is achieved for autofocusing.

In an advantageous construction, the image transmission branch extends in the center and the autofocusing branch extends at the periphery of the objective beam path, and the image transmission branch and the autofocusing branch run parallel to one another at least partially. Both branches are supplied with light from a common illumination source.

The out-coupling of the autofocusing branch can be carried out by means of a beam splitter which is arranged in the illumination beam path in front of an intermediate image plane and which, for this purpose, has a layer which passes the illumination light that is directed onto the surface of the observed object and reflects the light coming from the surface of the observed object in the autofocusing branch.

Further, devices according to the invention are provided for forming and evaluating three optical channels running within the autofocusing branch: a first optical channel supplies an extrafocal signal, a second optical channel supplies an intrafocal signal and a third optical channel supplies a signal that is conjugate in the direction of the optical axis, each for an autofocusing image plane.

To enable reliable detection of a defocused state, the optical channels are advantageously arranged next to one another and each channel has a confocal area and a nonconfocal area in its beam cross section.

In an advantageous construction, the confocal cross-sectional areas of the individual channels are formed by pinholes which are arranged in lines and/or columns and are arranged in the respective cross-sectional area of the respective channel.

The pinholes are preferably provided on areas with slit-shaped or narrow rectangular contours or outlines which are arranged for shaping the channels in the illumination beam path. The slit-shaped channels formed in this way correspond to a receiver line of the evaluating and adjusting unit, and every channel preferably images a surface region of the observed object on the associated receiver line.

In order to achieve the same imaging scale in all channels during this imaging, the receiver lines must be arranged so as to be offset with respect to the optical axis individually corresponding to the position of the respective associated channel.

However, it is also conceivable to provide receiver lines lying in a common plane for all three channels, so that, first, it is advantageously possible to detect the information from all channels at the same time and, second, a receiver component group (preferably with a plurality of receiver lines) can be used for all channels. While this does result in different imaging scales, it does not have disadvantageous consequences because the detection of the focus state is carried out by means of contrast measurement; different imaging scales in the receiver plane can be disregarded when detecting the focus position by means of contrast measurement.

For evaluation of the individual object regions and for correction of the focus position, the outputs of the receiver lines are connected to the signal inputs of the evaluating and adjusting unit.

Since the same illumination source is used for the object observation and for the autofocus system, autofocusing is carried out so as to be virtually completely optically conjugate. Further, the slit-shaped construction of the channels, object regions and receivers has the advantage that, in addition to the main image field, an autofocus image field is clearly visible.

The lateral offset of the autofocus measurement scene in x-direction and y-direction vertical to the direction of the principal optical axis Z, which occurs when inequalities in the observed object lead to a different image sharpness in the autofocus image field and main image field, can be compensated by the evaluating and adjusting unit through dynamic regulating parameters.

Another preferred construction of the arrangement according to the invention consists in that a spectral apparatus is arranged in the imaging plane of the optical channel transmitting the conjugate signal and, further, a Chromat objective is located in the objective beam path between the tube lens and objective for introducing a longitudinal chromatic aberration in a defined manner.

In this connection, the evaluation of a false color spectrum by means of the spectral apparatus is an additional criterion for the determination of the focal plane. The evaluation is carried out by comparing the currently detected color information to the stored color information for an ideal height profile. This method, known per se, is described, for example, in DE 197 13 362 A1 and DE 196 12 846 A1.

Another advantageous construction which is suitable particularly for confocal autofocusing in a microscope provides a polarizer as the main image splitter. Further, a quarter-wave plate is arranged between the objective and the tube lens, and the component of the polarized light which is reflected by the observed object and which now passes through the polarizer is directed to a reflection surface lying in the observation image plane.

The light component reflected at this surface once again arrives on the surface of the observed object and subsequently, after passing twice through the quarter-wave plate and polarizer so as to be reflected by the splitter layer of the polarizer after a corresponding polarization rotation, finally reaches the autofocusing branch. The use of polarized light advantageously enables a very good separation of false light and a light output in the receiver planes that is improved, in theory, by a factor of 2.

The invention will be described more fully in the following with reference to an embodiment example. In the accompanying drawings:

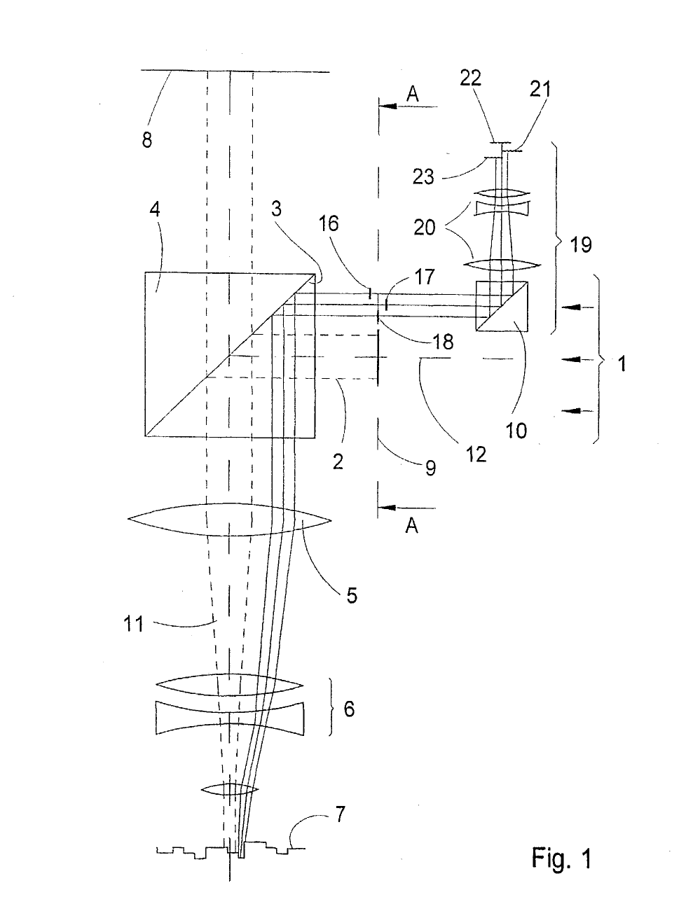

FIG. 1 is a schematic view of the arrangement for autofocusing at a microscope;

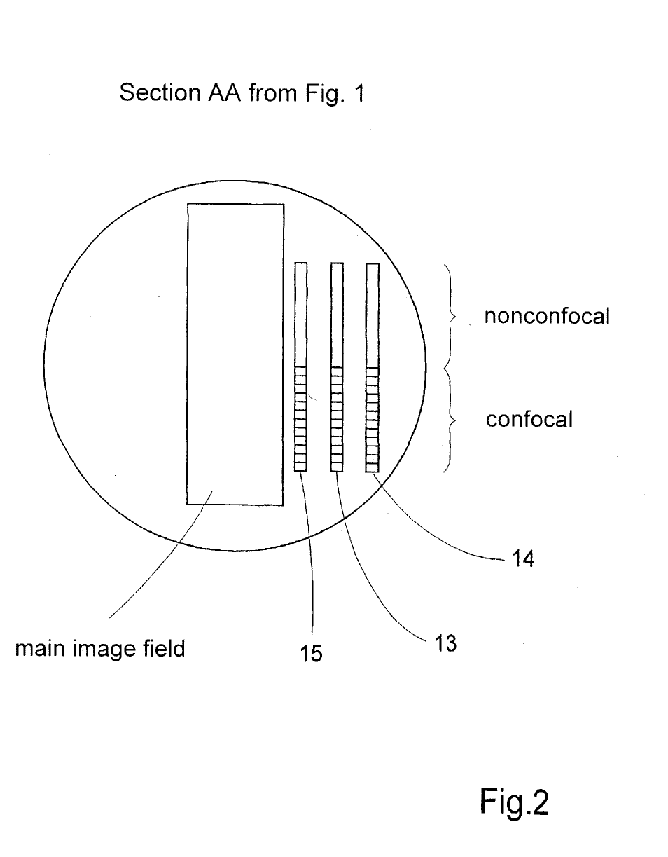

FIG. 2 shows the division of the illumination image field with the arrangement of the optical channels according to the invention;

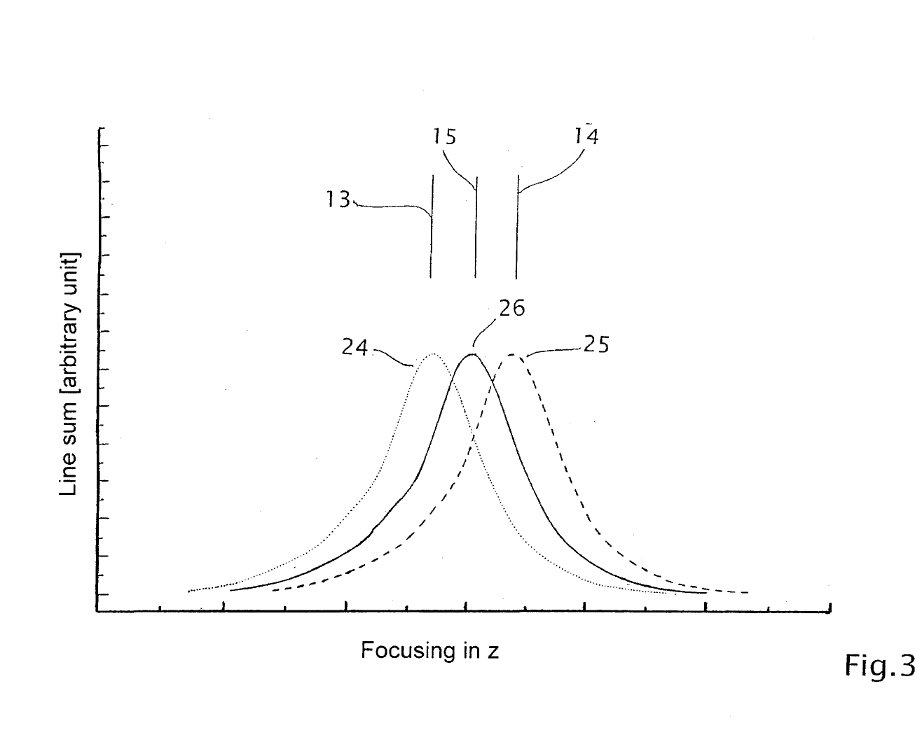

FIG. 3 shows an example for intensity functions depending on focus parameter z;

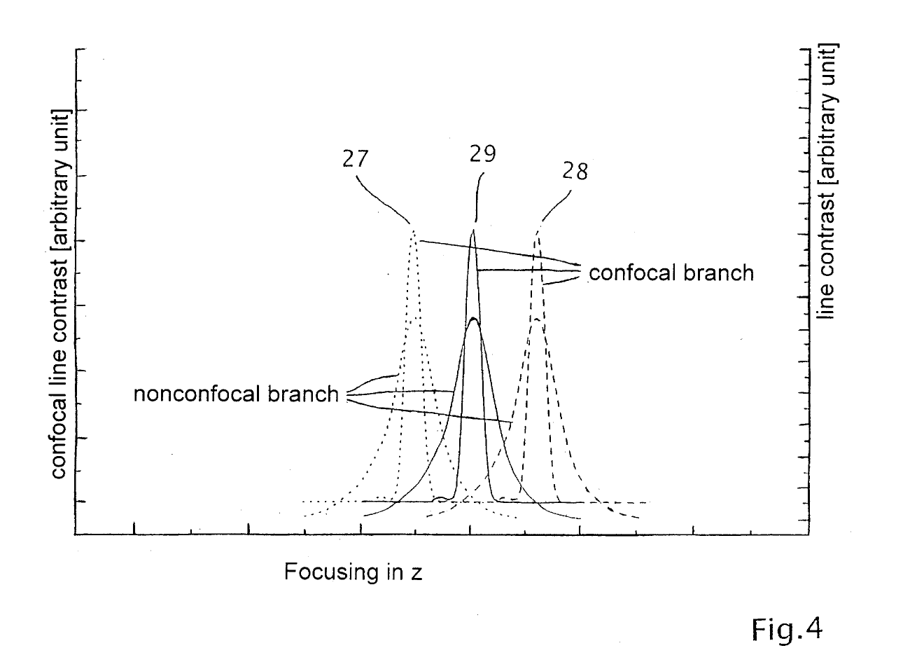

FIG. 4 shows an example for contrast functions depending on focus parameter z;

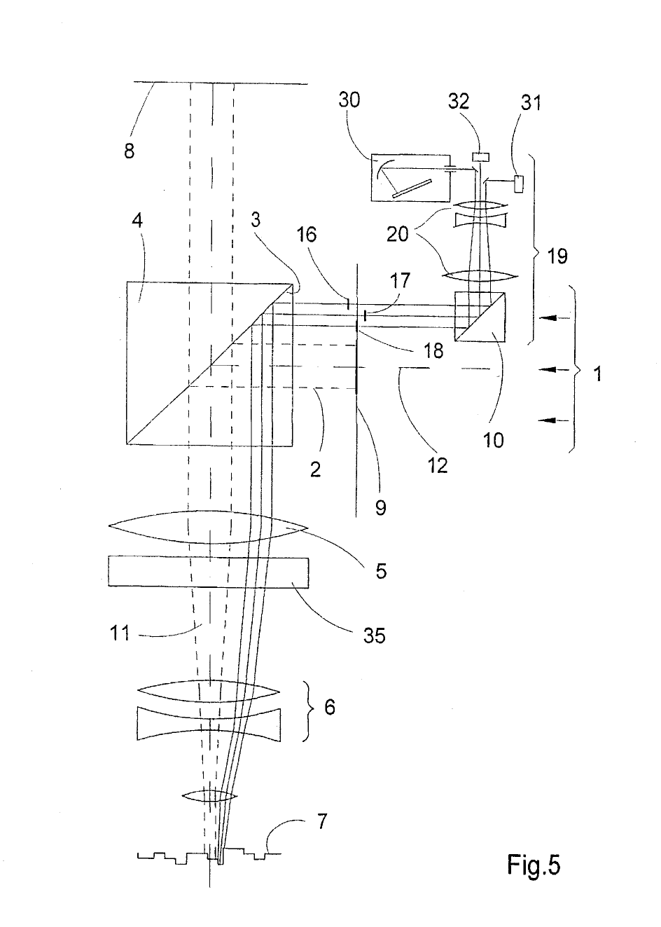

FIG. 5 shows the construction of the arrangement with spectral evaluation;

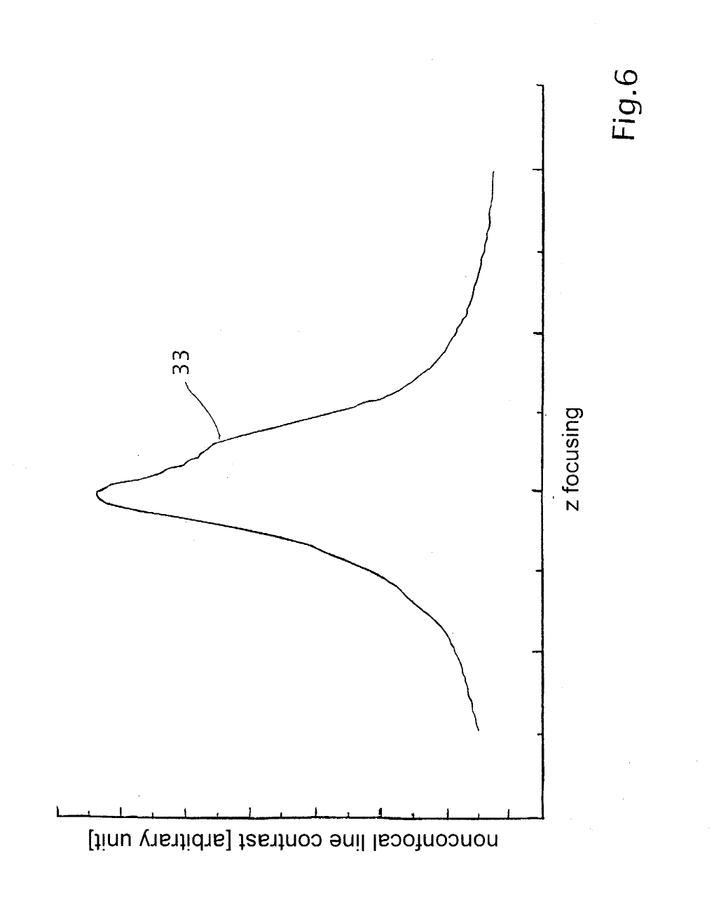

FIG. 6 is a view of a nonconfocal line contrast on a height-structured wafer surface;

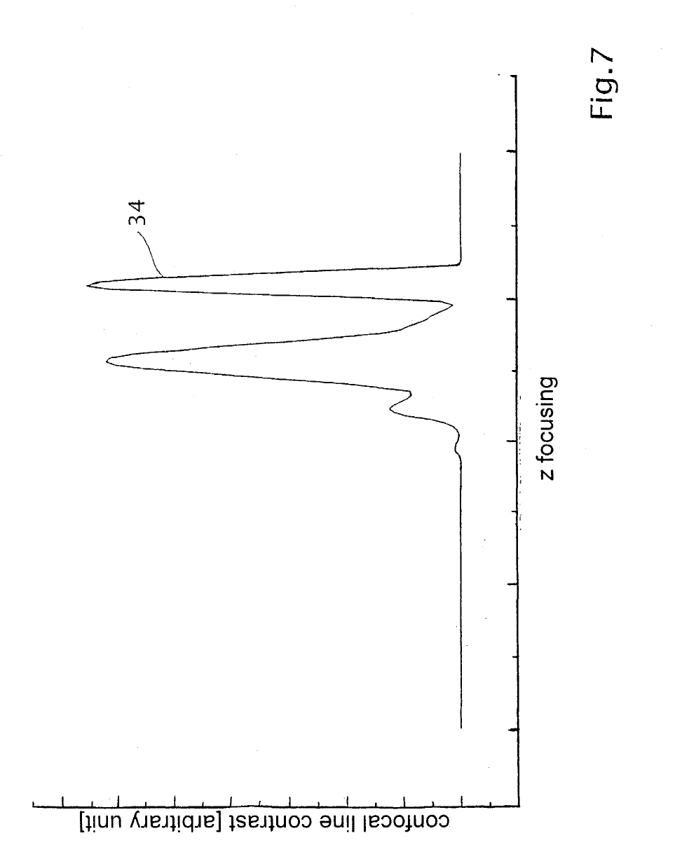

FIG. 7 is a view showing a confocal line contrast on a height- structured wafer surface;

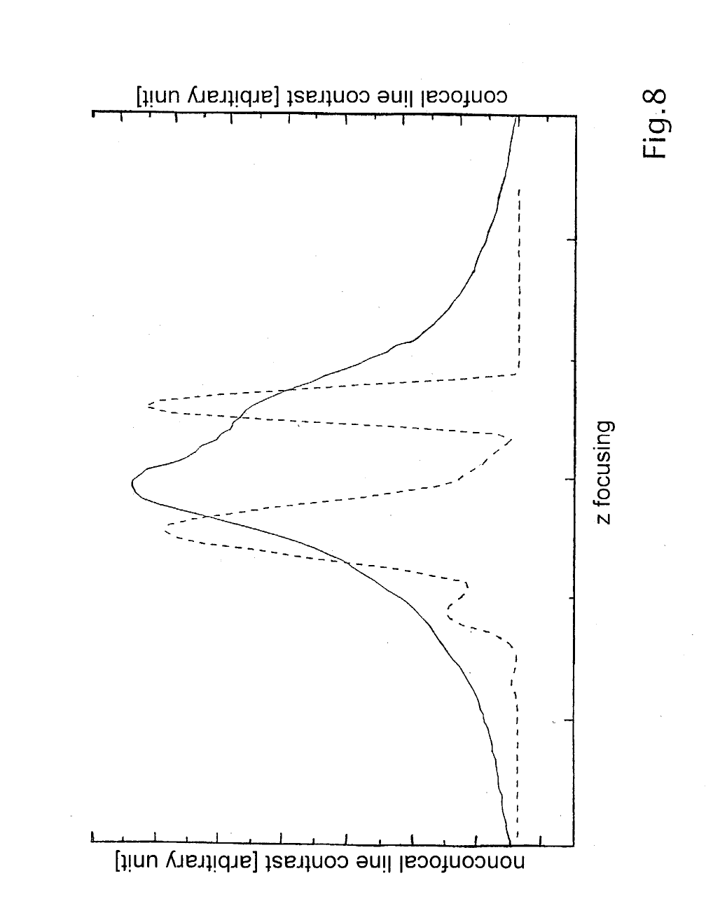

FIG. 8 shows the comparison of a nonconfocal line contrast to a confocal line contrast;

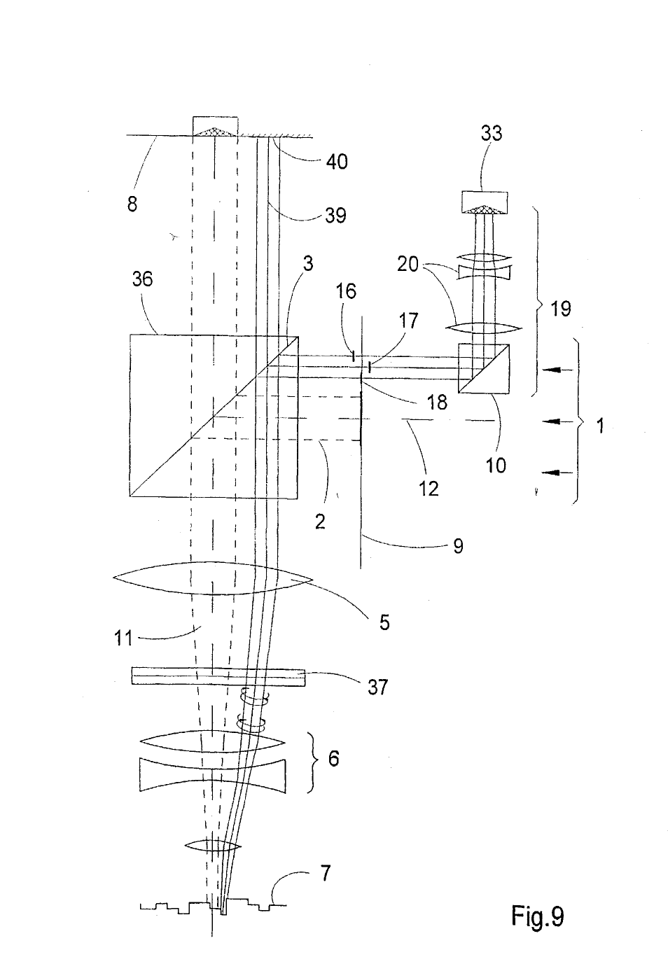

FIG. 9 shows the construction of the arrangement with polarized light.

The principle of confocal autofocusing according to the invention is shown by way of example in FIG. 1 in connection with a beam path for confocal microscopy.

The illumination beam path 2 coming from an illumination source 1 is directed onto an observed object 7 via the partially reflecting layer 3 of a main image splitter 4, a tube lens 5 and a focusing objective 6.

The light that is reflected or scattered by the observed object 7 travels back to the partially reflecting layer 3 and, through the latter, to an observation image plane 8 where the evaluation of the observed surface portion of the observed object 7 is carried out. A partial reflection takes place simultaneously at the partially reflecting layer 3 in an intermediate image plane 9.

According to the invention, the image information used for observation of the object and the information about the focus position are conveyed in different optical branches which are spatially separated from one another.

For this purpose, an autofocusing splitter prism 10 is located between the illumination source 1 and the intermediate image plane 9. The illumination light for the autofocusing branch penetrates the autofocusing splitter prism 10 before the intermediate image plane 9 and then travels at the periphery of the beam path 2.

The autofocusing branch extends between the observed object 7 or object plane and the partially reflecting layer 3 parallel to the image bundle 11 and from there passes along the return path back to the illumination beam path.

Three optical channels 13, 14 and 15 are formed next to one another in the autofocusing branch. Channel 13 supplies an extrafocal signal in an extrafocal plane 16, channel 14 supplies an intrafocal signal in an intrafocal plane 17, and channel 15 supplies a signal which is conjugate in the direction of the optical axis 12 in a conjugate plane 18. Plane 18 is located in optical conjunction to the field diaphragm of the main beam path.

FIG. 2 shows the division of the illumination beam path 2 in a section AA from FIG. 1 with the arrangement of the optical channels 13, 14, 15 within the total light bundle which is transmitted.

Each of the optical channels 13, 14, 15 has a confocal and a nonconfocal beam cross-sectional area. The confocal beam cross-sectional area of the channels 13, 14, 15 is formed by diaphragms which are arranged in planes 16, 17, 18 and have lines and/or columns of pinholes.

Further, FIG. 2 shows the main image field which generates a confocal image of the observed object 7 and is therefore structured.

The autofocusing splitter prism 10, effective only for the autofocusing branch or for the channels 13, 14 and 15, separates a sensor branch 19 beginning in the autofocusing splitter prism 10 (see FIG. 1).

The three optical channels 13, 14 and 15 reproducing the slit-shaped portions of the observed object 7 that lie close together are imaged along the sensor branch 19 by means of transmission optics 20 on receivers which are constructed in a slit-shaped manner and which are arranged so as to be offset relative to one another, their receiver surfaces being positioned in the autofocusing image planes 21, 22 and 23 shown in FIG. 1.

The processing of the signals which are supplied via the optical channels 13, 14 and 15 and converted optoelectronically by the receivers is carried out by an evaluating and adjusting unit, not shown in the drawings.

Reference is had to FIG. 3 and FIG. 4 for the following description of the evaluation and conversion of the signals into actuating commands for refocusing.

In order to generate the largest possible capture area, only the sum of the pixel intensity determined by the receivers is formed in the nonconfocal beam cross-sectional areas as a contrast function. As is shown in FIG. 3, separate intensity functions, each of which depends on a separate focus parameter z, are formed for each optical channel 13, 14 and 15. Intensity function 24 corresponds to the extrafocal channel 13, intensity function 25 corresponds to intrafocal channel 14, and intensity function 26 corresponds to the conjugate channel 15.

The intensity functions 24, 25 and 26 are bell curve functions which are shifted in z-direction and utilized for generating a focus direction signal, where, for an assumed focus point z1, a value Ie (z1) is measured for the extrafocal channel 13, a value Ii(z1) is measured for the intrafocal channel 14, and a value Ik(z1) is measured for the conjugate channel 15.

A required focus correction is determined in the following manner:

1. When Ie(z1) is less than Ii(z1), focusing is carried out in the extrafocal direction.

2. When Ie(z1) is greater than Ii(z1), focusing is carried out in the intrafocal direction.

3. When Ie(z1) is equal to Ii(z1), no focusing is carried out.

The boundary condition Ik(z1) is greater than Ie(z1) and Ii(z1) applies in this connection.

For fine focusing with high resolution, the confocal areas are evaluated in channels 13, 14 and 15. The sums are formed by the squares of the deviation of the pixel intensity from the average intensity in the confocal areas as contrast functions, for example.

Accordingly, three steep confocal contrast functions are formed, namely, an extrafocal contrast function 27, an intrafocal contrast function 28 and a conjugate contrast function 29, whose dependence on focus parameter z is shown in FIG. 4 together with the intensity functions 24, 25 and 26 of the nonconfocal area. In this case, there are three functions with a small half-width, each of which lies inside the broad intensity functions 24, 25 and 26 according to FIG. 3 and is highly dependent on the confocal parameters, pinhole diameter, imaging aperture and imaging magnification.

The need for fine focusing is determined as follows:

1. Measurement of the contrast functions in the same focus point z1, where the contrast function is defined as Ke(z1) for the extrafocal channel 13, as Ki(z1) for the intrafocal channel 14 and as Kk(z1) for the conjugate channel 15.

2. When Ke(z1) is less than Ki(z1), fine focusing is carried out in extrafocal direction.

3. When Ke(z1) is greater than Ki(z1), fine focusing is carried out in intrafocal direction.

4. When Ke(z1) is equal to Ki(z1), no focusing is carried out.

The boundary condition Kk(z1) is greater than Ke(z1) and Ke(z1) is approximately equal to Ki(z1) applies in this connection.

FIG. 5 shows the arrangement, according to the invention, which is further developed in that a spectral apparatus 30 is arranged in the autofocusing image plane of the conjugate channel 25 (see FIG. 1), while a slit-shaped receiver 31 is located in the autofocusing image plane of the extrafocal channel 13 and a slit-shaped receiver 32 is located in the autofocusing image plane of the intrafocal channel 14. A Chromat objective 35 is arranged in the objective beam path between the tube lens 5 and objective 6 for defined introduction of a longitudinal color error.

The use of the spectral apparatus 30 in connection with the Chromat objective 35 provides additional information for fine adjustment of the focal plane by evaluating a false color spectrum of the conjugate optical channel 15. The evaluation is carried out in the evaluating unit by comparing the currently determined color information to the stored color information for a correctly focused height profile.

Because of the height structuring of the observed object 7 a very complex situation results with confocal image generation in the main image field with respect to focus adjustment of an object scene. A multi-value contrast function 34 occurs in the main image as a function of the focus value z as is shown in FIG. 7.

FIG. 7 shows the characteristic in highly confocal imaging, that is, in observed objects with depth character and a plurality of reflecting observation planes of the observed object 7. Accordingly, different images of the observed object 7 are generated in different object planes by the focus value z corresponding to the characteristics of the observed object 7 such as height profile and reflection characteristics.

Therefore, it is possible to distinguish object planes in a definite manner, but only assuming height coding.

The conjugate channel 15 is generated in a completely confocal manner and illuminates the entrance slit of the spectral apparatus 30. The focusing is carried out in a manner analogous to the procedure already described. The same applies to the evaluation of the optical signals in the extrafocal and intrafocal channels 13 and 14, respectively, with respect to the nonconfocal beam cross- sectional areas. Different contrast functions are shown in FIG. 6, FIG. 7 and FIG. 8.

In order to be able to determine the focus plane in a definite manner, the false color spectrum of the conjugate channel 15 is evaluated in addition. When using a broadband illumination source 1, this spectrum has a fixed distance of the color maxima relative to one another. A reflection plane is selected by focusing the observed object 7 and subsequent observation of the spectrum such that the associated maximum is adjusted to the shortest-wave color of the illumination spectrum.

The confocal areas of the extrafocal and intrafocal channels 13 and 14 are evaluated for additional fine focusing. A definitive fine focusing of the preselected reflection plane is carried out in the above-described manner.

An additional construction of the arrangement according to the invention is shown in FIG. 9. Instead of the main image splitter 4 (FIGS. 1 and 5), a polarizer 36 is used. Further, a quarter-wave plate 37 is located between the objective 6 and the tube lens 5.

A component of the polarized light which is reflected by the observed object 7 and passes through the polarizer reaches the observed object 7 again via a reflection surface 40 arranged in the receiver focal plane 8 and is then deflected into the autofocusing branch through the arrangement of the quarter-wave plate 37 by the partially reflecting layer 3 of the polarizer 36.

In this case, the object regions defined by the channels 13, 14, 15 are imaged on only one receiver 33 by the transmission optics 20 corresponding to a construction that was already described.

The receiver 33 makes it possible to evaluate the extrafocal signal, intrafocal signal and conjugate signal at the same time. As was already described, the resulting differences in the imaging scales are negligible with respect to the determination of the focus position.

Reference numbers

| | |
|---|---|
| 1 | illumination source |
| 2 | beam path |
| 3 | partially reflecting layer |
| 4 | main image splitter |
| 5 | tube lens |
| 6 | objective |
| 7 | observed object |
| 8 | observation image plane |
| 9 | intermediate image plane |
| 10 | autofocusing splitter prism |
| 11 | image bundle |
| 12 | optical axis |
| 13 | extrafocal channel |
| 14 | intrafocal channel |
| 15 | conjugate channel |
| 16 | extrafocal plane |
| 17 | intrafocal plane |
| 18 | conjugate plane |
| 19 | sensor branch |
| 20 | transmission optics |
| 21, 22, 23 | autofocusing image plane |
| 24 | intensity function of extrafocal channel |
| 25 | intensity function of intrafocal channel |
| 26 | intensity function of conjugate channel |
| 27 | contrast function of extrafocal channel |
| 28 | contrast function of intrafocal channel |
| 29 | contrast function of conjugate channel |
| 30 | spectral apparatus |
| 31 | receiver line for extrafocal channel |
| 32 | receiver line for intrafocal channel |
| 33 | receiver |
| 34 | contrast function |
| 35 | Chromat objective |
| 36 | polarizer |
| 37 | quarter-wave plate |
| 39 | light component of polarized light |
| 40 | reflection surface |

1. Arrangement for confocal autofocusing in an optical device, preferably in a microscope, wherein an illumination beam path (2) is directed onto an observed object (7), and image information from the surface of the observed object (7) as well as information about the focus position is obtained from the light that is reflected in an objective (6) by the observed object (7) and, based on this information, a correction of the focus position is carried out by means of an evaluating and adjusting unit, characterized in that the image information and the information about the focus position are guided in different, spatially separated optical branches within the objective beam path, wherein the image transmission branch and the focusing branch are optically connected by a common illumination source (1), and apparatus is provided for forming and evaluating three optical channels (13, 14, 15) running within the focusing branch, a first optical channel supplies an extrafocal signal, a second optical channel supplies an intrafocal signal and a third optical channel supplies a signal that is conjugate in direction of the optical axis (12), each for a focusing image plane (21, 22, 23), wherein a light bundle (11) which serves as an image transmission branch runs in the center of the objective beam path and an autofocusing branch runs at the periphery of the objective beam path, and one of the channels (13, 14, 15) corresponds in each instance with a receiver device of the evaluating and adjusting unit, each of the channels (13, 14, 15) imaging a region of the surface of the observed object (7) on a receiver line (30, 31, 32).

2. Arrangement according to claim 1, characterized in that the optical channels (13, 14, 15) are arranged so as to extend next to one another and each channel (13, 14, 15) has a confocal area and a nonconfocal area in its beam cross section.

3. Arrangement according to claim 3, characterized in that slit- shaped diaphragms are arranged in the illumination beam path to form the channels (13, 14, 15), the diaphragms having pinholes arranged in lines and/or columns in the confocal areas.

4. Arrangement according to one of the preceding claims, characterized in that a Chromat objective (35) is provided in the objective beam path between the tube lens (5) and the objective (6), and a spectral apparatus (30) is provided in the autofocusing image plane (23) of the channel (15) supplying a conjugate signal.

5. Arrangement according to one of the preceding claims, characterized in that a beam splitter (10) with a layer which passes the illumination light that comes from the illumination source (1) and is directed onto the surface of the observed object (7) and which reflects the light coming from the surface of the observed object (7) in the autofocusing branch is arranged in front of an intermediate image plane (9) for coupling out the autofocusing branch from the illumination beam path.

6. Arrangement according to one of the preceding claims, constructed particularly for confocal autofocusing in a microscope in which the main image splitter (4) is constructed as a polarizer (36), a quarter-wave plate (37) is arranged between the objective (6) and the tube lens (5), the component of the polarized light (39) which is reflected by the observed object (7) and which passes through the polarizer (36) in the observation image plane (8) is directed onto a reflection surface (40) lying in the observation image plane (8), the polarized light (39) in the rear beam path strikes the observed object (7) again and, finally, after the fourth pass through the quarter-wave plate (37), has a polarization direction in which it is deflected by the splitter layer of the polarizer (36) to the sensor branch as an autofocus signal.
